(19) United States
(12) Patent Application Publication
(10) Pub. No.: US 2024/0284936 A1
(43) Pub. Date: Aug. 29, 2024

(54) MICROBE MODULATED VERMICULTURE

(71) Applicant: Soldier Sailor Agriculture, LLC, Mountlake Terrace, WA (US)

(72) Inventors: Beau Anable, Mountlake Terrace, WA (US); Iradj Stroble, Mountlake Terrace, WA (US)

(21) Appl. No.: 18/520,506

(22) Filed: Nov. 27, 2023

Related U.S. Application Data
(60) Provisional application No. 63/448,586, filed on Feb. 27, 2023.

(51) Int. Cl. A23K 10/26; A23K 50/80

(52) U.S. Cl. CPC A23K 10/26; A23K 50/80

(57) ABSTRACT

System for pretreating and processing animal manure into a protein meal and oil for use in fish and animal feed. The system uses composting to eliminate pathogens and then utilizes insects to convert the organic matter into protein. The insects are then processed and sold whole or as a protein meal and oil for use as ingredients in animal and fish feed.

### CROSS REFERENCE TO RELATED APPLICATION

This application claims priority from U.S. Provisional Application No. 63/448,586, filed on Feb. 27, 2023, entitled “MICROBE MODULATED VERMICULTURE,” the content of which is incorporated by reference herein in its entirety for all purposes.

### FIELD

An organic waste (animal manure) recycling system that uses insects for the conversion of manure into protein meal, oil, and/or fertilizer.

### BACKGROUND

Treating animal manure to generate feed presents numerous challenges that often makes the results less than ideal. As an example, if animal manure is not properly treated, greenhouse gas emissions may increase, often causing environmental challenges. Addressing such issues often requires significant resources, such as computational resources and additional human effort.

### BRIEF DESCRIPTION OF DRAWINGS

Various techniques will be described with reference to the drawings, in which:

FIG. 1 illustrates an example environment of an organic waste recycling system comprising one or more windrows, in accordance with at least one embodiment;

FIG. 2 illustrates an example environment indicating a cross sectional diagram of a windrow, in accordance with at least one embodiment;

FIG. 3 illustrates an example environment indicating a side view diagram of a windrow, in accordance with at least one embodiment;

FIG. 4 illustrates an example process of a production system for Black Soldier Fly Larvae (BSFL), in accordance with at least one embodiment;

FIG. 5 illustrates an example of a windrow turner used in an organic waste recycling system, in accordance with at least one embodiment; and

FIG. 6 illustrates a computing device that may be used, in accordance with at least one embodiment.

### DETAILED DESCRIPTION

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

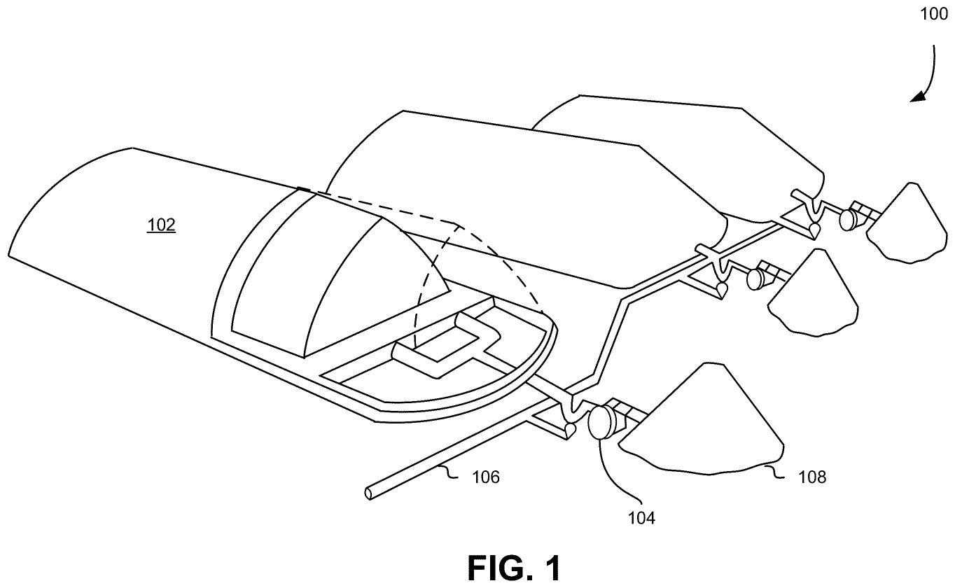

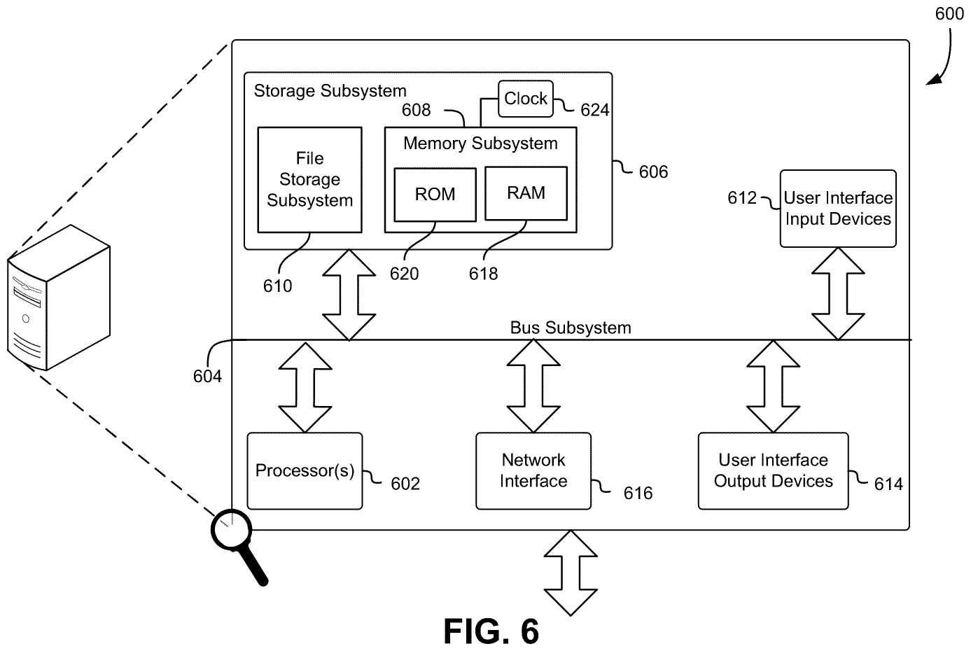

Techniques described below relate to systems and methods for pretreating and processing organic waste (e.g., animal manure) into a protein meal, oil, and/or fertilizer that may be used in fish and animal feed. In an embodiment, an organic waste recycling system processes animal manure into protein meal in one or more stages. In an embodiment, the organic waste recycling system performs waste pre-treatment in a first stage. Waste pre-treatment may include removing pathogens from the manure and early stage decomposition. In an embodiment, the organic waste recycling system performs larval feeding using Black Soldier Fly Larvae (BSFL) in a second stage. Larval feeding may include using a watering mechanism and a windrow turner to turn and/or rotate the organic matter in such a manner that moisture and temperature of the waste is maintained at a level that is hospitable for the BSFL. In an embodiment, for BSFL to be hospitable, it will need to be maintained at a level that allows the BSFL to grow, which requires the temperature and moisture levels to be maintained as described below (e.g., above 131 degrees Fahrenheit, but below 150 degrees Fahrenheit). In an embodiment, the organic waste recycling system performs larval harvesting in a third stage. Larval harvesting may include using a vibrating screener to separate the larvae and the wood chips. In an embodiment, the organic waste recycling system performs product processing in a fourth stage to eventually create protein meal and/or oil. Product processing may include using different devices to separate the protein meal from the oil. The one or more stages performed by the organic waste recycling system are described in more detail below with respect to FIGS. 1-6. In some embodiments, one or more computing devices, as described in FIG. 6 below, can be used to control the organic waste recycling system to perform operations described herein.

Animal manure is a nutrient rich substrate that also poses unique environmental and logistical challenges. In order to maximize the value of the nutrient rich waste, it must be properly treated and processed to provide safe and valuable end products. Larvae has the ability to consume organic waste in the form of food waste, animal manure, human feces, and/or carrion. In an embodiment, as the larvae consume the waste, the larvae can grow to a point that it can be harvested and further processed, using the techniques described herein, into protein meal and oil for use in animal and fish feed. The byproduct of the larvae consuming the waste, using the techniques described herein, include BSFL frass, a compost like material that is free of the pathogens found in the untreated organic waste and has value as a fertilizer or soil amendment.

Techniques described herein are directed to systems and methods that eliminates pathogens in order to process a wider selection of waste (e.g., animal manure) to generate protein meal. By processing animal manure to generate protein meals, potential greenhouse gas (GHG) reductions can be greatly reduced. Other manure management systems exist, such as bioreactors for methane capture, which have the potential to compete for resources. However, these systems have yet to exhibit a sustainable manure management system at an economically viable scale and efficiency. Hence, techniques described herein use a microbe modulated vermiculture system to provide production for BSFL that can safely utilize manure as feedstock while producing a BSFL product that is compliant with U.S. Food and Drug Administration (FDA) regulations for animal feed. BSFL may be used as the basis in a manure management system at all major concentrated animal feeding operations (CAFO's). This will drastically reduce GHG emissions generated by agriculture, provide enough BSFL meal and frass to mitigate fish meal and synthetic fertilizer demand, and improve food security for the population.

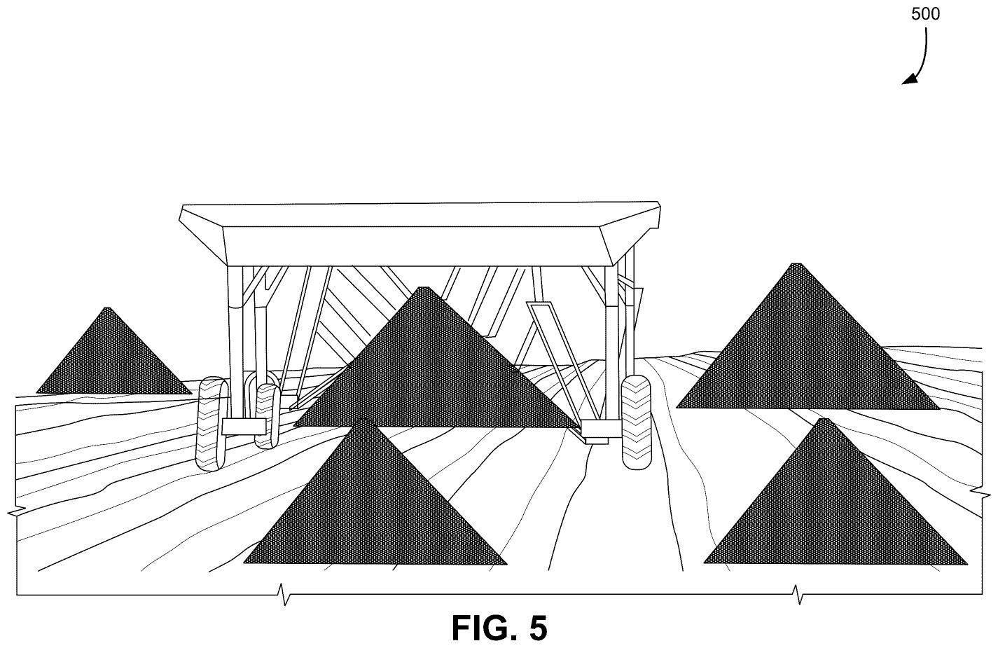

FIG. 1 illustrates an example environment of an organic waste recycling system 100 comprising one or more windrows 102, in accordance with at least one embodiment. Organic waste recycling system 100 is also referred to herein as an animal manure recycling system or a microbe modulated vermiculture system. FIG. 1 illustrates an organic waste recycling system 100 as an aerated static pile system. In an embodiment, organic waste recycling system 100 comprises a fan 104 to pump air into an aerated static pile (also referred herein as a windrow or simply a pile), a drain 106 for condensation drainage, and an exhaust pile 108 to filter odor. Although only one fan 104 is illustrated in FIG. 1 for each pile, there may be instances where more than one fan is used. In an embodiment, an aerated static pile is used for the one or more windrows 102 where there is no turning of the materials in the aerated static pile. Instead, the aerated static pile relies on a fan 104 to pump air into the pile. In an embodiment, the fan 104 uses one or more pipes (e.g., Polyvinyl Chloride (PVC), stainless steel, Acrylonitrile butadiene styrene (ABS), etc.) to pump air into the one or more windrows 102. However, in some instances, other devices or systems can be used to pump air into pile. For example, instead of using a fan, one or more air pumps, one or more blowers, a forced ventilation system, a negative pressure system, or the like can be used to supply air into the pile. In an embodiment, in an aerated static pile, air is pumped into the feedstock (e.g., manure) using one or more blowers and piping to maintain a fairly constant level of oxygen in the material. This may, in an embodiment, allow the microbes to be consistently active and the aerated static pile to maintain a temperature above 131 degrees Fahrenheit, but under 150 degrees Fahrenheit. In an embodiment, the biolayer on top helps further insulate the aerated static pile so that all of the material reaches the necessary temperature to kill pathogens without having to mix it. In an embodiment, the organic waste recycling system 100 uses a variety of composting methods to include but not limited to windrow, aerated static pile, in vessel, etc. for waste pre-treatment and larval feeding. In an embodiment, the use of a windrow turner to mix the materials instead of using an aerated static pile system is described in more detail in FIG. 5 below.

In an embodiment, organic waste recycling system 100 uses BSFL to process animal manure. In an embodiment, organic waste recycling system 100 creates an environment that is suitable for larval growth. In an embodiment, organic waste recycling system 100 treats manure to remove pathogens, feed it to the larvae until fully grown, then harvest and process the larvae into a protein meal and an oil for use in animal feed. In an embodiment, as the larvae consume the manure left behind, an excrement (e.g., frass) can be collected and used as fertilizer. In an embodiment, processing manure with BSFL reduces GHG emissions by up to 99% compared to other manure management systems and further BSFL meals can replace fish meal in industrial aquaculture. Yet even further, BSFL frass can reduce synthetic fertilizer demand while rebuilding soil quality.

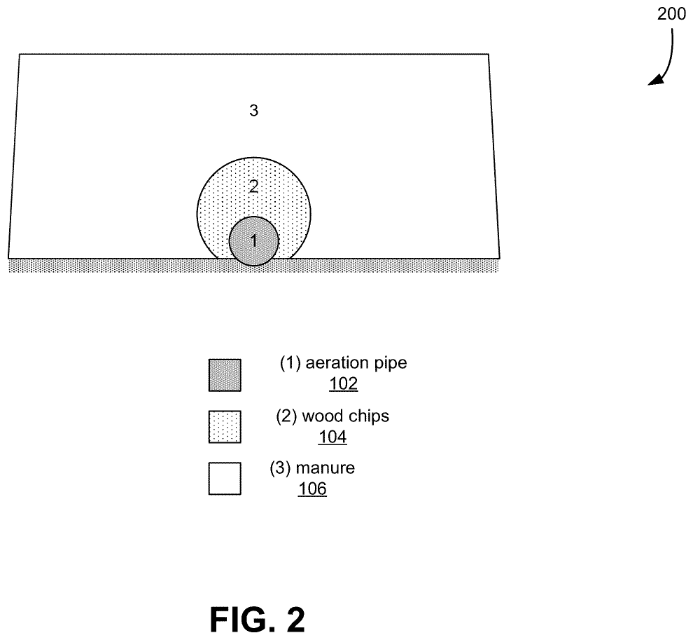

The organic waste recycling system 100 may be performed in four phases: waste pre-treatment, larval feeding, larval harvesting, and product processing (which are described in further detail below and also in the description of FIGS. 2-5). In an embodiment, the waste pre-treatment phase prepares the raw material to meet FDA requirements for food-grade ingredients and begins decomposition to increase digestibility of manure for the BSFL. The waste pre-treatment may eliminate all pathogens in the waste to be safely fed to the BSFL. The larval feeding phase may consist of feeding the newly processed material to the BSFL until the larva are fully grown. In the third phase, the BSFL may be separated from the frass and screened from the frass in preparation for use as a soil amendment. In the fourth phase, the BSFL may be processed into a protein meal and oil. In some embodiments, the first three phases are completed outdoors in any weather conditions, whereas the final phase may be completed in a weather protected area due to the machinery used to process the BSFL. The warehouse used for BSFL processing may not require any special ventilation or climate control requirements. Each of the four phases of microbe modulated vermiculture are performed using one or more devices (e.g., windrow turners, spraying system, air blowers, watering devices, etc., which are explained below in further detail. In some embodiment, the four phases of the microbe modulated vermiculture can be controlled by one or more computing devices as described in FIG. 6 below.

### Phase 1: Pathogen Removal

In this phase, aerated static pile composting may be used to remove pathogens from the manure. The aerated static pile consists of a perforated pipe connected to an air blower. Wood chips or finished compost are placed over the pipe to ensure the holes do not get blocked and to assist in even airflow from the pipe. After the wood chips or compost are in place, the manure may be laid on top in the form of a compost windrow 102. A biolayer of finished compost may then be placed over the manure to serve as insulation and as a filter for noxious emissions. Once the pile has been created, the air blower may run intermittently to push oxygen to the microbes, allowing for the aerobic activity that will heat the pile to at least 131 degrees Fahrenheit or above. However, the threshold of 131 degrees Fahrenheit is provided as an example embodiment, and other thresholds below that may also be plausible. The pile's temperature may be held above 131 degrees Fahrenheit for at least 72 hours to meet the FDA requirements for pathogen removal. However, the FDA requirements for the length of time that the pile's temperate needs to be at can vary based on varying factors (e.g., FDA change of requirements). Inside the pile there may be one or more sensors that continuously monitor the temperature to ensure the temperature stays above 131 degrees Fahrenheit. In some embodiment, the one or more sensors are controlled by one or more computing devices (such as that described in FIG. 6 below). In some embodiments, the one more sensors are controlled by a user providing inputs to the one or more computing devices, where the one or more computing devices are configured to send and receive data from the one or more sensors. After the 72 hour requirement is complete the blower may be stopped and the organic waste may be considered a feed grade ingredient.

### Phase 2: Growing the Black Soldier Fly Larvae

Phase 2 begins by cooling the organic waste. In an embodiment, water is added until the moisture content slows the aerobic decomposition process. Further, the manure may be turned using a windrow turner. Once the temperature of the pile is at least below 90 degrees Fahrenheit, five day old larvae (5DOL) may be added to the pile. Moisture and temperature are then monitored to ensure the manure remains at optimal conditions for the larva. In some embodiments, the moisture and temperature is monitored by the one or more computing devices mentioned in FIG. 6. In some embodiments, the temperature required before adding 5DOL may be lower or higher than 90 degrees Fahrenheit. Moisture may be maintained at approximately 75% by mass in order to modulate the activity of thermophilic microorganisms that are responsible for traditional composting. This moisture percentage is well above the 40-60% required for traditional composting and keeps the temperature of the organic waste hospitable for the BSFL to continue growth. In some embodiments, the moisture level can also be altered to be higher or lower than 75% and/or a different range than 40-60%.

In an embodiment, a windrow turner is also used for several purposes. For example, the windrow turner can assist in moisture control, uniform mixing of the larvae within the pile, and provide an additional means of temperature control. The windrow turner, when used, causes moisture to be added. In an embodiment, windrow turner is used with a sprayer system so that moisture is added back to the whole pile, ensuring a sustainable environment for the larvae to feed and grow. The windrow turner may also spread the larva evenly throughout the organic waste. The larva have a tendency to migrate toward one another and form large groups, causing them to be unevenly distributed. In an embodiment, turning the pile breaks up pockets of unprocessed waste and allows for the complete processing of the feedstock. The final function of the windrow turner may be used to serve as a secondary means of temperature control. Turning the pile releases excessive heat and provides oxygen to the system. Phase 2 is complete when the larva have begun entering the prepupae stage. This is identified by visual inspection of one or more users (or via sensors connected to one or more computing devices as described in FIG. 6) for changes in the color of the larva and the growth of a hook-like protrusion.

In an embodiment, the windrow turner turns the pile to cool the pile by adding water to the pile, which in turn provides moisture to the pile. In an embodiment, the moisture can be maintained at a constant level by adding water to replenish what has evaporated from the pile. In an embodiment, with windrows that contain larva, it may be preferred to maintain the pile to be below 100 degrees Fahrenheit. In an embodiment, when the temperature exceeds 100 degrees Fahrenheit, the pile can be further turned or rotated to bring the temperature down below 100 degree Fahrenheit.

In an embodiment, factors that determine the size of the windrow can be based on an ambient temperature of a pile. In at embodiment, the windrow size may change as the hotter it is, the smaller the windrow and vice versa. In an embodiment, factors that determine how much to turn the windrow may include: a Carbon-to-Nitrogen ratio (e.g . . . , the hotter it is outside means there is more carbon), moisture levels (e.g., the moisture levels may stay within a relatively small band so that there is enough pore space for larva to penetrate), and/or turning schedule. In an embodiment, the turning schedule can be initially set up to turn at about once every 2-3 days, but it will vary based on weather and the factors mentioned above monitored over an approximately 3 week cycle.

Phase 3: Separating the Larvae from the Fertilizer

The larvae may be harvested after approximately ten (10) to fourteen (14) days, the time it takes for them to enter the prepupae stage. In some embodiments, the number days that the larvae may be harvested may be altered. Harvesting consists of using a two deck horizontal vibrating screener. The purpose of the first deck is to separate the wood chips from the frass and the larvae. The function of the second screen is to separate the larvae from the frass. The exact size of the screener is dependent on the waste. For example, one-half (½) inch and one-quarter (¼) inch of the screener may be used, but other sizes may also be applicable.

Phase 4: Processing the Larvae into Protein Meal and Oil

Once the larvae have been separated from the wood chips and frass, the larvae may then be processed to separate the protein meal from the oil. Separating the two may extend the shelf life of the products and allow them to be stored and shipped to customers. The first step in the process may be to dry the larvae. This is accomplished using a rotating dehydrator. The second step may conclude separating the protein meal from the oil using a screw press. The final step is to grind the protein meal into a uniform granular size using an industrial coffee grinder (or something similar).

FIG. 2 illustrates an example environment indicating a cross sectional diagram of a windrow 200 (e.g., compost windrow), in accordance with at least one embodiment. In an embodiment, organic waste recycling system comprises a windrow 200. In an embodiment, windrow 200 is the same or similar windrow as described above with respect to FIG. 1. In an embodiment, windrow 200 illustrates an aeration pipe 102, wood chips 104 that are on top of the pipe, and manure or food 106. In an embodiment, the windrow 200 comprise an aerated static pile that consists of a perforated pipe 102 (e.g., aeration pipe) connected to an air blower (not depicted in FIG. 2, but as described in FIG. 1). Wood chips 104 or finished compost are placed over the perforated pipe 102 to ensure the holes do not get blocked and to assist in even airflow from the perforated pipe 102. After the wood chips 104 or compost are in place, the manure 106 may be laid on top to form the compost windrow 200. A biolayer of finished compost may then be placed over the manure to serve as insulation and as a filter for noxious emissions. Once the pile has been created, the air blower may run intermittently to push oxygen to the microbes, allowing for the aerobic activity that will heat the pile

In an embodiment, said windrow 200 is configured to eliminate approximately megatons of CO2-e. Some of the megatons comes from reducing manure emissions while the remaining megatons comes from a reduction in synthetic fertilizer production. Although composting is also a part of the process as described in FIG. 1 and in the other figures below, the non-BSFL composting phase may take a fraction of the time than conventional composting systems and further uses a biofilter to prevent GHG emissions. In an embodiment, a 99% reduction of megatons, where for each ton of BSFL meal sold, GHG emissions can be reduced by at least 1.71-6.29 tons.

The fertilizer value represents a 50% reduction in emissions from nitrogen fertilizer production. In an embodiment, the emissions from just the production of nitrogen fertilizer and calculated 50% to arrive at the fertilizer value. In an embodiment, per ton of frass sold, 0.05 tons of CO2-e GHG is eliminated.

In an embodiment, using said organic waste recycling system would also reduce GHG in other ways. These include reductions in manure transportation due to performing the processing on-site, pesticide production due to frass serving as a natural pesticide, reduction of non-nitrogen fertilizer use, decreasing land application of raw manure, and increased soil biomass due to frass application. When these factors are included, the total GHG reduction may be much higher.

While the systems required to process manure at the scale of industrialized CAFO's are more complex, basic farming equipment is all that is needed to adopt a small-scale version of the organic waste recycling system. Many users can either use the larvae as a high-quality protein for their own livestock or sell it as an additional revenue stream. Using frass instead of applying raw manure significantly decreases the potential for pathogen transfer, is of higher fertilizer value, and serves as a natural pesticide. In developed countries, the overwhelming majority of livestock are located at a few CAFOs. By turning manure into three high value products, increased profitability can be obtained for farmers rather than forcing them to pay for current manure management systems.

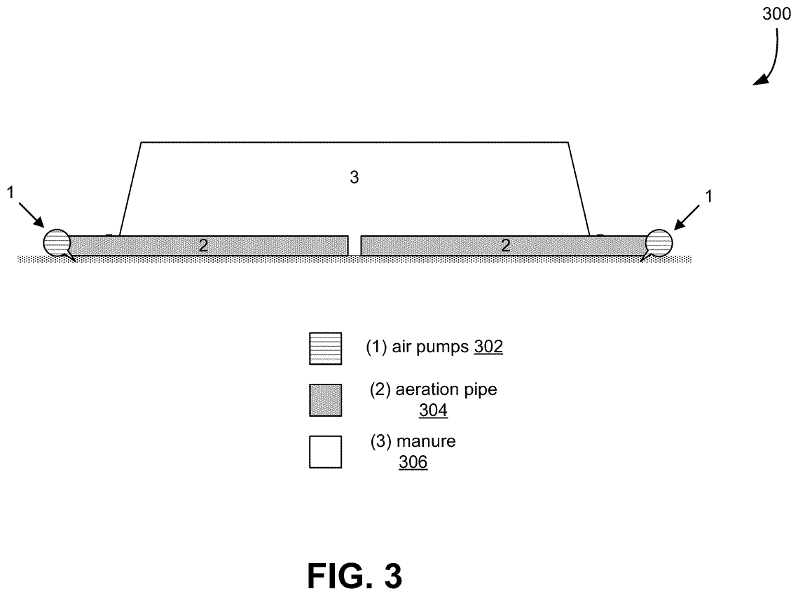

FIG. 3 illustrates an example environment indicating a side view diagram of a windrow 300 (e.g., compost windrow), in accordance with at least one embodiment. In an embodiment, organic waste recycling system (as described in FIG. 1 above) comprises windrow 300 to perform the processing of manure to generate protein meal as disclosed herein. In an embodiment, windrow 300 is the same or similar windrow as described above with respect to FIG. 1. As shown in FIG. 3, side view of windrow 300 comprises at least: one or more air pumps 302, an aeration pipe 304, and a manure of food waste 306.

At scale, organic waste recycling system generates BSFL meal and oil serving as animal feed ingredients, while BSFL frass can be used as fertilizer. Organic waste recycling system uses widespread adoption of BSFL. In an embodiment, during the testing phrase, organic waste recycling system tests for pathogens at each phase of said process to verify the safety of the protein meal.

In an embodiment, both organic and conventional fertilizer can be produced by organic waste recycling system. Organic waste recycling system collocates the BSFL feeding and growth stage on dairies who can then apply the frass to their crop fields, eliminating the need for transport. Organic waste recycling system can be used around central breeding hubs that can ship to remote areas, which provides location flexibility that minimizes transport costs and limits the movement of manure and frass. Organic waste recycling system may use the frass as fertilizer. Depending on the environment, each market will require fine tuning, as changes in manure composition produce some variations in frass nutrients and farmers have differing soil nutrient needs. In some embodiments, the fine turning of the system can be controlled by one or more computing devices as described in FIG. 6 below. In an embodiment, frass is well rounded nutritionally and can be implemented as a base product with some synthetics or other organic products added to meet specific needs of different environments.

As previously stated, the organic waste recycling system is transformational in its ability to rear BSFL off a wide variety of waste streams to include manure, and that it can be implemented in regions that lack sophisticated infrastructure. The operations provided by the organic waste recycling system may be used in farming operations as current BSFL operations have over-engineered production to achieve ideal growth parameters. By loosening those parameters, a small reduction in larval growth, efficiency is traded for a substantial reduction in costs and broader waste capabilities. In an embodiment, the organic waste recycling system comprises the manipulation of microbial activity involved in manure decomposition to foster a habitable environment for the larva, while others use standard climate control systems. This may lower energy demands, increases location flexibility, and can provide suppliers and customers economic incentives. Additionally, the organic waste recycling system can be replicated with little capital expenditure for small farms in countries lacking complex infrastructure. The organic waste recycling system may require relatively little investment and be easy to operate.

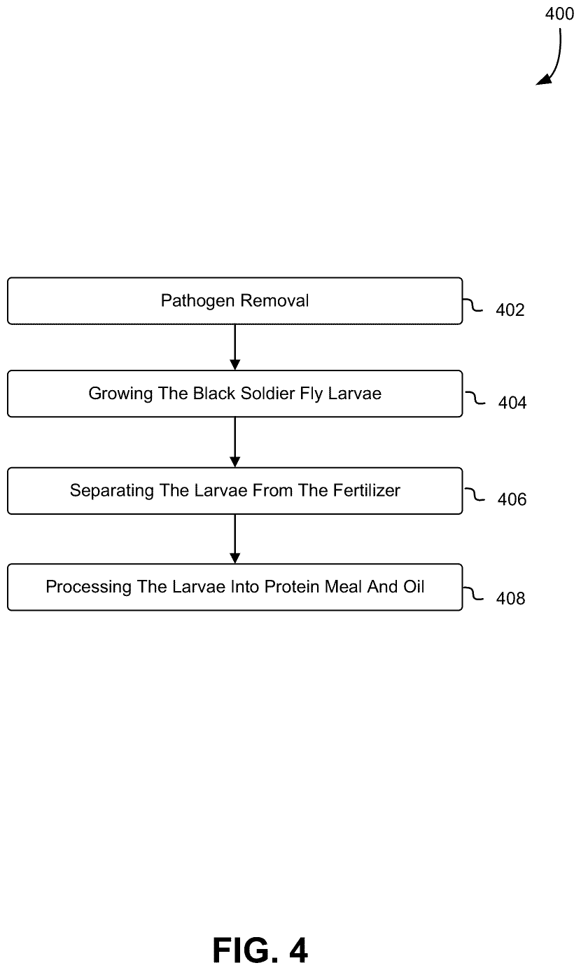

FIG. 4 illustrates an example process 400 of a production system for BSFL, in accordance with at least one embodiment. In an embodiment, production system is the organic waste recycling system (as described above in FIGS. 1-3), which can be used to treat manure for pathogens so that it can be used as a feedstock for larvae. In an embodiment, process 400 can be implemented and controlled by one or more computing devices described in FIG. 6 below. To sell the larval end products, the waste fed to the BSFL must be compliant with the Association of American Feed Control Officials (AAFCO) definitions of food grade ingredients. The organic waste recycling system may use composting as a process to further reduce pathogens (PFRP) 402 before feeding the manure to the larvae. The organic waste recycling system can broaden available waste streams to include animal manure and still be AAFCO compliant. This allows the organic waste recycling system to drastically reduce GHG emissions from manure while also yielding a frass that has a higher fertilizer value than if produced on food waste due to the higher NPK content of the feedstock. In addition to the GHG reduction and fertilizer value, using manure may also be necessary if BSFL operations are to reach the scale necessary to meaningfully reduce demand for fish meal and synthetic fertilizer. While food waste exists in large amounts, it is dwarfed by the amount of manure produced in industrial farming. The organic waste recycling system may be configured to integrate composting, repurpose its biological processes, and modify them to create the environment necessary for growing BSFL.

The organic waste recycling system comprising a BSFL operation further consists of three phases: a breeding and hatching phase 404, a larval feeding phase 406, and a harvesting/processing phase 408. These phases are also all disclosed above in FIG. 1. In an embodiment, the feeding phase is where the waste is consumed and the larvae grow, and requires certain environmental conditions to optimize growth.

When waste is placed into a compost windrow, the microbes present in the waste may begin decomposition, which generates heat. Standard compost is typically kept at a temperature above 131 degrees Fahrenheit and composting manure often reaches temperatures of 150 degrees Fahrenheit or higher, which may be too hot for BSFL growth. However, several variables, such as moisture, aeration, and/or time, can be adjusted to alter the biological activity and change the environment of the windrow. By manipulating these variables, the organic waste recycling system can create the ideal environment for BSFL growth. This eliminates the need for expensive climate control, high-tech automated warehouses, or high labor costs. In some embodiments, the variables can be adjusted using one or more computing devices as described in FIG. 6 below.

The organic waste recycling system's BSFL feeding process may occur outdoors and uses farm equipment that is easy to source and incredibly affordable. The organic waste recycling system may organize the manure into long windrows where it composts normally until it meets AAFCO guidelines, then the composting parameters can be adjusted until the manure is suitable for the larvae. The organic waste recycling system adds the larvae as feed until ready to harvest, changing variables as necessary to maintain the optimal growth environment. This requires a trained operator who understands how to modulate the composting process, but minimal equipment and labor is needed. In some embodiments, one or more computing devices (as described in FIG. 6) can also be used to modulate the composting process. In some embodiments, the one or more computing devices uses one or more machine learning models to modulate the composting process. After the larvae are fed, the larvae are harvested using equipment. The organic waste recycling system may be designed to separate the larvae from the frass. The larvae may then be dehydrated, pressed, and milled to create the final protein meal and oil products. The result is an organic waste recycling system that can process manure, produce BSFL at a price comparable to market alternatives, and one capable of being exported to developing countries to increase food security.

Unlike the conventional model where inputs and outputs remain nearly identical with each larval life cycle, the organic waste recycling system is more akin to farming. Varying weather conditions and manure composition can affect how composting variables need to be modified to produce a certain environment and more tests are needed to optimize this process.

Other techniques can be used to process and generate protein meal. For instance, a deep neural network (e.g., a generator network trained to determine composting variables) can be used to manipulate the composting variables (e.g., moisture, aeration, and time). In some instances, composting can be influenced by other factors such as carbon-nitrogen ratio, temperature, pH value, and/or raw material size of composting. In an embodiment, the composting variable depends in part on the weather, moisture, and/or oxygenation. In an embodiment, historical data (e.g., weather conditions) and previous testing related to the moisture levels can be fed to a neural network for training, which can then be used to manipulate the composting variables to process and generate protein meal. Generally, it should be noted that the embodiments described herein are illustrative in nature and one with ordinary skill in the art will appreciate variations that are within the scope of the present disclosure. In some embodiments, the one or more computing devices as described below in FIG. 6 can be used to train the deep neural network and perform predictions related to the composting variables using the deep neural network.

In at least one embodiment, a processor of a computing system uses one or more neural networks to generate one or more variables to control a windrow turner based, at least in part, on environmental factors such as those listed above. In at least one embodiment, a system is a collection of one or more hardware and/or software computing resources with instructions that, when executed, performs one or more communication processes such as those described herein. In at least one embodiment, the system is a software program executing on computer hardware, application executing on computer hardware, and/or variations thereof. In at least one embodiment, one or more processes of the system are performed by any suitable processing system or unit (e.g., graphics processing unit (GPU), general-purpose GPU (GPGPU), parallel processing unit (PPU), central processing unit (CPU), data processing unit (DPU)), in any suitable manner, including sequential, parallel, and/or variations thereof. In at least one embodiment, the system uses a machine learning training framework such as PyTorch, TensorFlow, Boost, Caffe, Microsoft Cognitive Toolkit/CNTK, MXNet, Chainer, Keras, Deeplearning4j, and/or other training framework to implement and perform operations described herein to generate one or more variables (e.g., how much rotation is needed to turn the windrow turner such that the waste is maintained a predetermined temperature level) for the windrow turners based, at least in part, on environmental factors (e.g., carbon-nitrogen ratio, temperature, pH value, and/or raw material size of composting). In at least one embodiment, a neural network model is trained to generate one or more variables (e.g., rotational speed) to control the one or more windrow turners using the sensory data obtained from the environment where the windrow tuner is located. The sensory data may be obtained via one or more sensory devices (e.g., temperature reading device, moisture reading device, pH reading device, etc.).

FIG. 5 illustrates an example of a windrow turner 500 used in an organic waste recycling system (as described above in FIGS. 1-4), in accordance with at least one embodiment. In an embodiment, with windrow composting, instead of pumping or forcing air into the pile (as described in an aerated static system in FIGS. 1-3 above), air is introduced by turning a pile with a windrow turner 500, which mixes all the materials together and oxygenates it. The windrow turner 500 may perform all the same stages as described in FIGS. 1-3, the only difference being that air is not pumped into the pile, but oxygen is provided to the pile via turning and mixing the materials. In an embodiment, by using the windrow turner 500, the oxygen levels of the pile then slowly decline as it is consumed by microbes, causing temperatures to decline, until the pile is turned again. The turning may also ensure the material on the outside of the pile is mixed into the hotter core area. The mixing and turning can be performed at different phases and/or speeds depending on a variety of factors (e.g., environmental, materials being mixed, etc.) The number of times the materials need to be turned and mixed using the windrow turner 500 can also be controlled via an external system, controller, or by a user based on the materials being mixed and environmental factors. As illustrated in FIG. 5, the windrow turner 500 can be an earth moving equipment, self-propelled compost turner, a straddle turner, side turner or a device/equipment that has a combination of capabilities from different types of turners.

FIG. 6 illustrates a computing device 600 that may be used, in accordance with at least one embodiment. FIG. 6 is an illustrative, simplified block diagram of a computing device 600 that can be used to practice at least one embodiment of the present disclosure. In various embodiments, the computing device 600 includes any appropriate device operable to send and/or receive requests, messages, or information over an appropriate network and convey information back to a user of the device. The computing device 600 may be used to implement and/or control any of the systems illustrated and described above. For example, the computing device 600 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 600 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 6, the computing device 600 may include one or more processors 602 that communicate with and are operatively coupled to a number of peripheral subsystems via a bus subsystem. In some embodiments, these peripheral subsystems include a storage subsystem 606, comprising a memory subsystem 608 and a file/disk storage subsystem 610, one or more user interface input devices 612, one or more user interface output devices 614, and a network interface subsystem 616. Such storage subsystem 606 may be used for temporary or long-term storage of information.

In some embodiments, the bus subsystem 604 may provide a mechanism for enabling the various components and subsystems of computing device 600 to communicate with each other as intended. Although the bus subsystem 604 is shown schematically as a single bus, alternative embodiments of the bus subsystem utilize multiple buses. The network interface subsystem 616 may provide an interface to other computing devices and networks. The network interface subsystem 616 may serve as an interface for receiving data from and transmitting data to other systems from the computing device 600. In some embodiments, the bus subsystem 604 is utilized for communicating data such as details, search terms, and so on. The network interface subsystem 616 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UPnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering. Many protocols and components for communicating via such a network are well known and will not be discussed in detail. In an embodiment, communication via the network interface subsystem 616 is enabled by wired and/or wireless connections and combinations thereof.

In some embodiments, the user interface input devices 612 include one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 600. In some embodiments, the one or more user interface output devices 614 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 600. The one or more user interface output devices 614 can be used, for example, to present user interfaces to facilitate user interaction with software applications performing processes described and variations therein, when such interaction may be appropriate.

In some embodiments, the storage subsystem 606 provides a computer-readable storage medium for storing the basic programming and data constructs that provide the functionality of at least one embodiment of the present disclosure. The software applications (programs, source code modules, instructions), when executed by one or more processors in some embodiments, provide the functionality of one or more embodiments of the present disclosure and, in embodiments, are stored in the storage subsystem 606. These software application modules or instructions can be executed by the one or more processors 602. In various embodiments, the storage subsystem 606 additionally provides a repository for storing data used in accordance with the present disclosure. In some embodiments, the storage subsystem 606 comprises a memory subsystem 608 and a file/disk storage subsystem 610.

In embodiments, the memory subsystem 608 includes a number of memories, such as a main random access memory (RAM) 618 for storage of instructions and data during program execution and/or a read only memory (ROM) 620, in which fixed instructions can be stored. In some embodiments, the file/disk storage subsystem 610 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 600 includes at least one local clock 524. The at least one local clock 524, in some embodiments, is a counter that represents the number of ticks that have transpired from a particular starting date and, in some embodiments, is located integrally within the computing device 600. In various embodiments, the at least one local clock 524 is used to synchronize data transfers in the processors for the computing device 600 and the subsystems included therein at specific clock pulses and can be used to coordinate synchronous operations between the computing device 600 and other systems in a data center. In another embodiment, the local clock is a programmable interval timer.

The computing device 600 could be of any of a variety of types, including a portable computer device, tablet computer, a workstation, or any other device described below. Additionally, the computing device 600 can include another device that, in some embodiments, can be connected to the computing device 600 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 600 for processing. Due to the ever-changing nature of computers and networks, the description of the computing device 600 depicted in FIG. 6 is intended only as a specific example for purposes of illustrating the preferred embodiment of the device. Many other configurations having more or fewer components than the system depicted in FIG. 6 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object level interfaces. The computing device 600 may include any appropriate hardware, software and firmware for integrating with a data store as needed to execute aspects of one or more software applications for the computing device 600 to handle some or all of the data access and business logic for the one or more software applications. The data store, in an embodiment, includes several separate data tables, databases, data documents, dynamic data storage schemes, and/or other data storage mechanisms and media for storing data relating to a particular aspect of the present disclosure. In an embodiment, the computing device 600 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 600 may provide access to content including, but not limited to, text, graphics, audio, video, and/or other content that is provided to a user in the form of HTML, XML, JavaScript, CSS, JavaScript Object Notation (JSON), and/or another appropriate language. The computing device 600 may provide the content in one or more forms including, but not limited to, forms that are perceptible to the user audibly, visually, and/or through other senses. The handling of requests and responses, as well as the delivery of content, in an embodiment, is handled by the computing device 600 using PHP: Hypertext Preprocessor (PHP), Python, Ruby, Perl, Java, HTML, XML, JSON, and/or another appropriate language in this example. In an embodiment, operations described as being performed by a single device are performed collectively by multiple devices that form a distributed and/or virtual system.

In an embodiment, the computing device 600 typically will include an operating system that provides executable program instructions for the general administration and operation of the computing device 600 and includes a computer-readable storage medium (e.g., a hard disk, random access memory (RAM), read only memory (ROM), etc.) storing instructions that if executed (e.g., as a result of being executed) by a processor of the computing device 600 cause or otherwise allow the computing device 600 to perform its intended functions (e.g., the functions are performed as a result of one or more processors of the computing device 600 executing instructions stored on a computer-readable storage medium).

In an embodiment, the computing device 600 operates as a web server that runs one or more of a variety of server or mid-tier software applications, including Hypertext Transfer Protocol (HTTP) servers, FTP servers, Common Gateway Interface (CGI) servers, data servers, Java servers, Apache servers, and business application servers. In an embodiment, computing device 600 is also capable of executing programs or scripts in response to requests from user devices, such as by executing one or more web applications that are implemented as one or more scripts or programs written in any programming language, such as Java®, C, C#, or C++, or any scripting language, such as Ruby, PHP, Perl, Python, or TCL, as well as combinations thereof. In an embodiment, the computing device 600 is capable of storing, retrieving, and accessing structured or unstructured data. In an embodiment, computing device 600 additionally or alternatively implements a database, such as one of those commercially available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more software applications) executing collectively on one or more processors, by hardware, or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

1. A method, comprising:
modifying organic waste by removing one or more pathogens from the organic waste;
adding water and Black Soldier Fly Larvae (BSFL) to the modified organic waste;
rotating the modified organic waste according to a predetermined level that allows the BSFL to grow with the modified organic waste;
separating one or more larvae from the modified organic waste comprising the BSFL; and
generating protein meal based on the one or more larvae.

2. The method of claim 1, further comprising:
using one or more windrow turners to rotate the modified organic waste based, at least in part, on the temperature of the modified organic waste.

3. The method of claim 1, further comprising:
causing the modified organic waste to be laid on top of an aerated static pile.

4. The method of claim 1, further comprising:
causing a biolayer of finished compost to be placed over the modified organic waste to serve as insulation and a filter for noxious emissions.

5. The method of claim 1, further comprising:
causing one or more fans to pump air into an aerated static pile comprising the modified organic waste to cause the aerated static pile to be maintained at or above a predetermined temperature.

6. The method of claim 1, further comprising:
using one or more neural networks to predict the predetermined level that allows the BSFL to grow with the modified organic waste.

7. The method of claim 1, wherein the predetermined level corresponds to a moisture and/or a temperature level of the modified organic waste.

8. A system, comprising:
one or more devices to:
modify organic waste by removing one or more pathogens from the organic waste to reach a first predetermined temperature;
cause the modified organic waste to reach a second predetermined temperature by rotation of the modified organic waste;
add Black Soldier Fly Larvae (BSFL) after the modified organic waste reaches the second predetermined temperature;
rotate the modified organic waste according to a moisture and temperature level that allows the BSFL to grow with the modified organic waste;
separate one or more larvae from the modified organic waste comprising the BSFL; and
process the one or more larvae to generate protein meal.

9. The system of claim 8, wherein the one or more devices are to:
add a biolayer of finished compost on top of the modified organic waste; and
use one or more blowers to heat the modified organic waste to the first predetermined temperature; and
use one or more sensors to monitor the moisture and temperature level of the modified organic waste to ensure that the modified organic waste is at or above the first predetermined temperature.

10. The system of claim 9, wherein the one or more devices are to:
rotate the modified organic waste to cause the modified organic waste to reach the second predetermined temperature; and
add, based on the modified organic waste at or below the second predetermined temperature, one or more 5-day-old-larvae (5DOL) to the modified organic waste.

11. The system of claim 10, wherein the one or more devices are to separate one or more wood chips, frass, and one or more larvae from the modified organic waste.

12. The system of claim 8, wherein the one or more devices are to:
cause the separated one or more larvae to dry; and
generate the protein meal by separating the protein meal from oil.

13. The system of claim 8, further comprising one or more processors to train one or more neural networks to generate one or more parameters to be used to control the one or more devices.

14. An apparatus, comprising:
one or more devices to:
remove one or more pathogens from organic waste;
cause the organic waste, after removal of the one or more pathogens, to meet a predetermined temperature;
add Black Soldier Fly Larvae (BSFL) after organic waste meets the predetermined temperature;
rotate the organic waste according to a level that allows the BSFL to grow with the organic waste;
separate one or more larvae from the organic waste comprising the BSFL; and
process the one or more larvae to generate protein meal.

15. The apparatus of claim 14, wherein the one or more devices are to:
spray water to the organic waste while rotating the organic waste.

16. The apparatus of claim 15, wherein the one or more devices are to:
rotate the organic waste to cause the organic waste to reach the predetermined temperature and a moisture level.

17. The apparatus of claim 14, wherein the one or more devices are to separate one or more larvae and one or more wood chips from the organic waste to generate the protein meal.

18. The apparatus of claim 14, wherein the one or more devices are to:
rotate the organic waste based, at least in part, on one or more temperature levels determined by one or more monitoring devices.

19. The apparatus of claim 14, wherein the protein meal is to be used as ingredients in animal and fish feed.

20. The apparatus of claim 14, further comprising using one or more computing devices to use one or more neural networks to adjust one or more variables used to control the one or more devices.
